(19) United States
(12) Patent Application Publication
(10) Pub. No.: US 2009/0276852 A1
(43) Pub. Date: Nov. 5, 2009

(54) STATISTICAL WORM DISCOVERY WITHIN A SECURITY INFORMATION MANAGEMENT ARCHITECTURE

(75) Inventors: Jimmy L. Alderson, Alpharetta, GA (US); Iven Connary, Smyrna, GA (US); Ori Pomerantz, Austin, TX (US); Peter Szczepankiewicz, Virginia Beach, VA (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUSINESS MACHINES CORPORATION, ARMONK, NY (US)

(21) Appl. No.: 12/113,533

(22) Filed: May 1, 2008

(51) Int. Cl. G06F 21/00

(52) U.S. Cl. 726/23

(57) ABSTRACT

A method, system, and computer program product for identifying a worm attack on a computer network. The method includes setting a predetermined time period for monitoring non-packet event(s). A log entry associated with the packet event(s) is received and stored. The one or more received log entries identify a first source of a worm infection threat, first destination(s) of the worm infection threat, first timestamp(s) of the worm infection threat, and a non-packet event type of the worm infection threat. A counter is configured for recording, within the predetermined time period, a number of infection attempts of the same event type by the first destination(s) of the worm infection threat to a second destination(s) of the worm infection threat. In response to determining that the number of infection attempts satisfies a defined infection attempt threshold value, an alert confirming the worm attack on the computer network is communicated.

### BACKGROUND OF THE INVENTION

The present disclosure relates to the detection of network worms, and specifically, to a method and system for enabling the detection of a worm attack in a computer network using Security Information Management (SIM).

Security Information Management (SIM) is an industry-specific term in the area of computer security that refers to the collection of data into a central repository for trend analysis. This is a basic introductory mandate in a computer security system. More specifically, SIM includes the particular aspect of information security infrastructure that discovers anomalous behavior (i.e., such as the propagation of worms and/or viruses) by using data collection techniques.

Worms spread in a network by the replication of one infected host onto neighboring hosts. The worms generate Internet Protocol (IP) addresses in a random manner and breed/spawn their worm code onto the hosts, which are active in that randomly generated space of IP addresses. The breeding of worms is exponential in nature and thus early detection of worm infection is desirable.

In conventional techniques, the outbreak of a worm in a network can be detected by the use of Intrusion Detection Systems (IDS) or Intrusion Prevention Systems (IPS). Most current IDS detect known network attacks by comparing the traffic on the network with known attack signatures. However, due to non-availability of presently unknown signatures, discovering new worm attack outbreaks can be difficult. Typically, such signatures can only be obtained after detailed analysis and reverse engineering of the new worm. However, this process is time-consuming.

Another conventional technology, known as Anomaly Detection (AD) technology, involves modeling the normal behavior of targets such as hosts, networks, and servers over a period of time. AD systems generate a normal profile of the targets, known as a baseline. Any new behavior from these targets triggers an anomalous event. However, even when the host tries to use a new legitimate service for the first time, these events are susceptible to false positives/alarms.

Another mechanism/process for worm discovery in a computer network can include correlating the spread of IP addresses in a worm's randomly generated IP address space, along with the worm's packet signature and a role-reversal behavior. The role reversal behavior implies that the role of a host changes from initially being a target to being a propagator of the worm attack. However, such a mechanism is limited to evaluating packet-level data. In several instances, such packet-level data may be unavailable.

There are several reasons for the unavailability of packet-level data. One possible reason is when there is no packet sniffer to capture the packet-level data for further analysis. Moreover, even assuming that a packet sniffer is available to capture the packet-level data, the data packets may be already encrypted upon capture. For example, worms that propagate via e-mail may be encrypted.

Another disadvantage of evaluating the detection of worms from packet-level data is that such a mechanism/process overlooks the propagation of worms or viruses that propagate within a specific network computer. Such a type of self-contained propagation could result in significant compromise in security should a vulnerability (i.e., hole) in a mainframe operating system (OS) be discovered by an attacker. Lastly, such packet-level worm discovery would be difficult to implement in the case of worm propagation through file sharing. While network packets could be used in a file sharing case to identify a worm, a user would have to reconstruct the file activity out of a packet stream. Such reconstruction would consume a considerable amount of time and system resources.

### SUMMARY OF THE ILLUSTRATIVE EMBODIMENTS

In view of the foregoing, a method, system, and computer program product for identifying a worm attack on a computer network are disclosed. A predetermined time period for monitoring one or more non-packet events among a plurality of network events is set. A log entry associated with the one or more packet events is received. The one or more received log entries identify a first source of a worm infection threat, at least one first destination of the worm infection threat, at least one first timestamp of the worm infection threat, and a non-packet event type of the worm infection threat. The one or more log entries are stored. An infection attempt threshold value is defined. A counter is configured for recording, within the predetermined time period, a number of infection attempts by the at least one first destination of the worm infection threat to at least one second destination of the worm infection threat. The worm infection threat has the same non-packet event type in the first source, the at least one first destination, and the at least one second destination. A determination is made whether the number of infection attempts satisfies the infection attempt threshold value. In response to determining that the number of infection attempts satisfies the infection attempt threshold value, an alert confirming the worm attack on the computer network is communicated.

All objects, features, and advantages of the present invention will become apparent in the following detailed written description.

### BRIEF DESCRIPTION OF THE DRAWINGS

Aspects of the invention itself will best be understood by reference to the following detailed description of an illustrative embodiment when read in conjunction with the accompanying drawings, where:

FIG. 1 depicts an exemplary computer in which the present invention may be implemented;

FIG. 2 is an exemplary worm attack pattern, wherein an embodiment of the invention can be practiced;

FIG. 3 depicts, in tabular format, additional details related to the exemplary network worm attack pattern shown in FIG. 2 that are useful for understanding the invention;

FIG. 4 depicts a particular subset of the exemplary network worm attack pattern depicted in FIG. 3 that is useful for understanding the invention; and

FIG. 5 is a high-level flow chart depicting an exemplary method for identifying a worm attack on a computer network, according to an embodiment of the present invention.

### DETAILED DESCRIPTION OF THE DRAWINGS

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a tangible computer-usable storage medium having computer-usable program code embodied in the storage medium and therein processible by a computer.

Any suitable tangible computer-usable or computer-readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber cable, RF, etc.

Computer program code for carrying out operations of the present invention may be written in an object oriented programming language such as JAVA® (JAVA is a registered trademark of Sun Microsystems, Inc.), Smalltalk® (SMALLTALK is a trademark or registered trademark of Cincom Systems, Inc.), C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

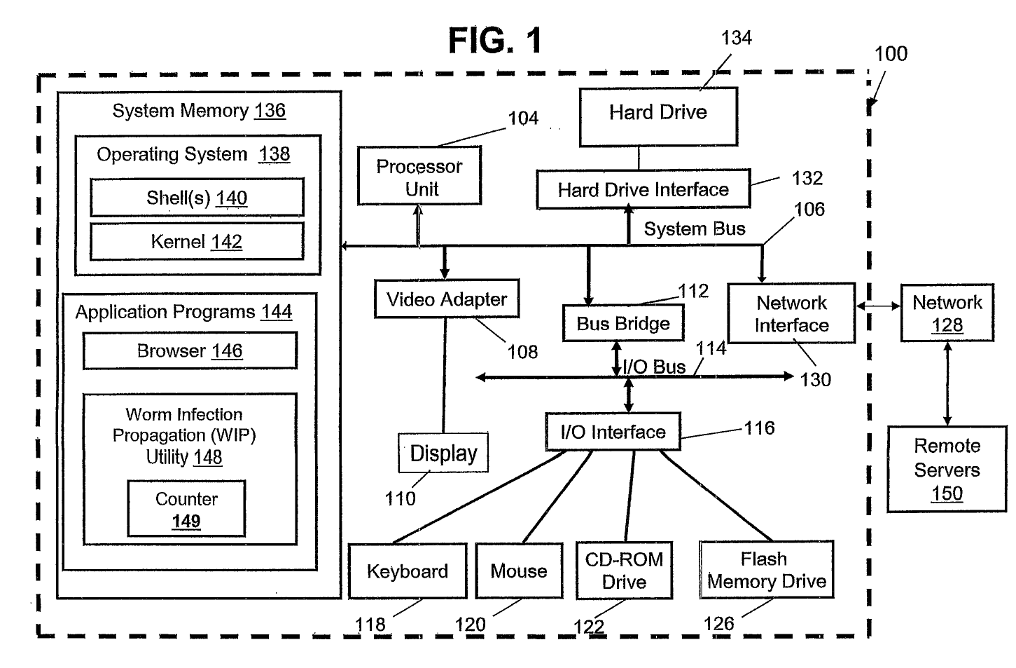

With reference now to the figures, and in particular to FIG. 1, there is depicted a block diagram of an exemplary data processing system (DPS) 100, with which the present invention may be utilized. DPS 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk—Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

DPS 100 is able to communicate with a remote server 150 via a network 128 using a network interface 130, which is coupled to system bus 106. Network 128 may be an external network such as the Internet, or an internal network such as an Ethernet or a Virtual Private Network (VPN). Remote server 150 may be architecturally configured in the manner depicted for DPS 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in DPS 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX® (UNIX is a registered trademark of The Open Group)) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

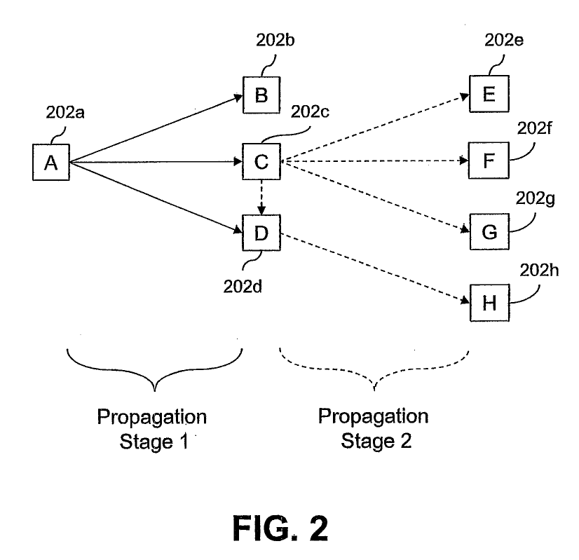

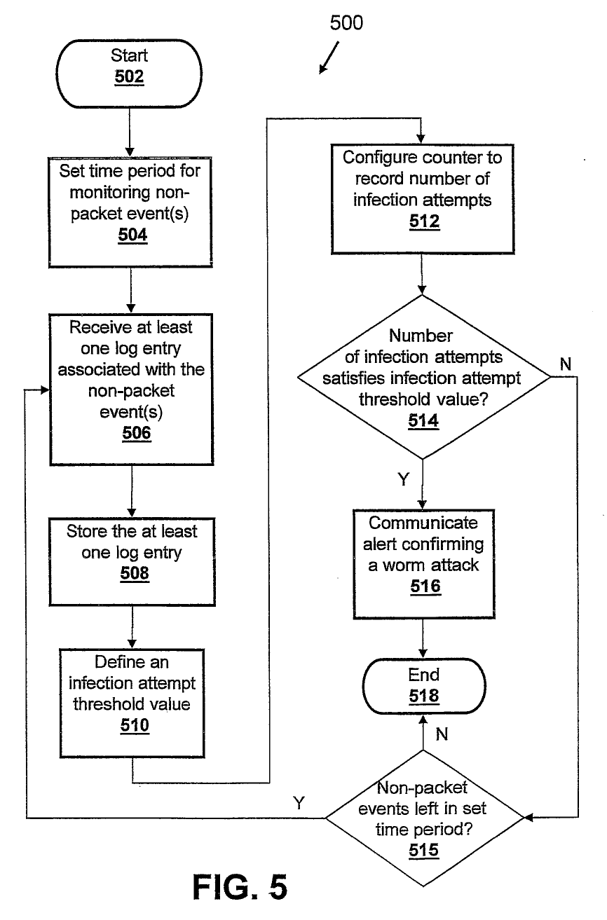

Application programs 144 include a browser 146. Browser 146 includes program modules and instructions enabling a World Wide Web (WWW) client (i.e., DPS 100) to send and receive network messages to the Internet. DPS 100 may utilize HyperText Transfer Protocol (HTTP) messaging to enable communication with remote server 150. Application programs 144 in system memory 136 also include a Worm Infection Propagation (WIP) Utility 148. WIP utility 148 performs the functions illustrated below in FIG. 5, and may include all logic, helper functions, databases and other resources depicted below in FIGS. 2-4. WIP utility 148 processes electronic signals from a multitude of sources, such as remote server 150 in network 128, as well as from other application programs 144.

The hardware elements depicted in DPS 100 are not intended to be exhaustive, but rather represent and/or highlight certain components that may be utilized to practice the present invention. For instance, DPS 100 may include alternate memory storage devices such as magnetic cassettes, Digital Versatile Disks (DVDs), Bernoulli cartridges, and the like. These and other variations are intended to be within the spirit and scope of the present invention.

FIG. 2 illustrates an exemplary computer network worm attack pattern, wherein an embodiment of the invention can be practiced. According to the embodiment shown, the computer network includes entities 202a through 202h. Each entity 202a-202h is defined by, but is not limited to, a computer, a user account within a same computer, and/or a computer program within the same computer. As can be appreciated by a person of ordinary skill, entity 202a-202h can also refer to any hardware or software component which can serve as a source or a destination for the propagation of a computer worm. The propagation of the computer worm, from a source to a destination, is represented in FIG. 2 by solid and dashed arrows. For example, in the attack pattern, entity 202a (denoted as block “A”) attempts to attack entities 202b, 202c, and 202d (denoting blocks “B”, “C”, and “D”, respectively). This first exemplary attack represents a first worm propagation stage and is denoted by solid arrows. Within the context of the first worm propagation stage, entity 202a serves as a first source of a worm infection threat and entities 202b, 202c, and 202d serve as a first destination of the worm infection threat.

The attack pattern continues in a second worm propagation stage represented by dashed arrows. According to the second propagation stage, entity 202c attempts to attack entity 202d, and entities 202e, 202f, and 202g (denoting blocks “E”, “F”, and “G”, respectively). In this regard, entity 202c, which previously served as a first destination of the worm infection threat in the first worm propagation stage, is now acting as a source of the worm infection threat in the second worm propagation stage. Moreover, entity 202d is shown to propagate the computer worm to entity 202h (denoted by block “H”). Thus, within the second worm propagation state, entities 202d-202h individually serve as a second destination of the worm infection threat.

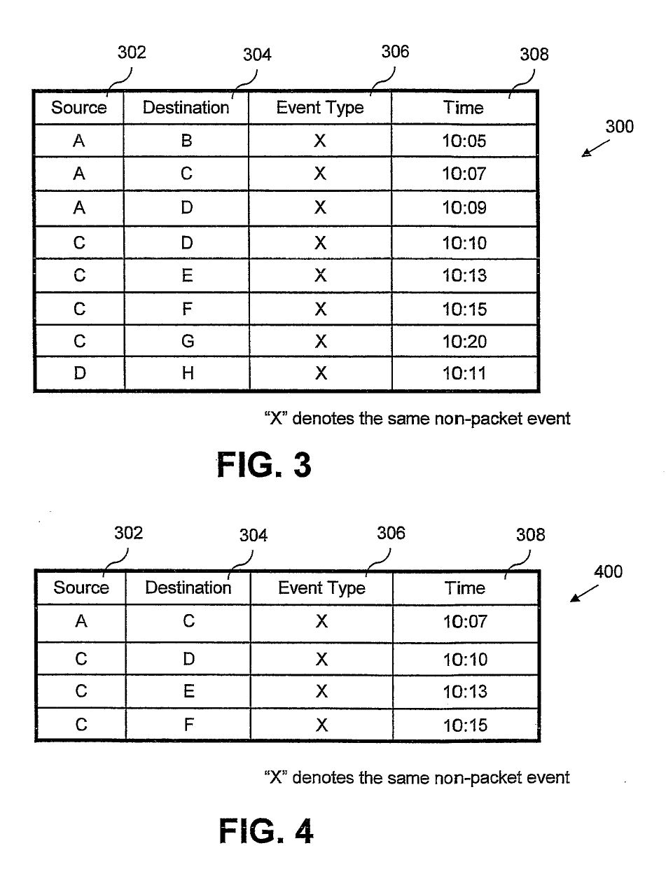

FIG. 3 shows an exemplary table log 300 that depicts a set of log entries that contain additional details related to the exemplary network worm attack pattern shown in FIG. 2. The exemplary network worm attack pattern is made up of various non-packet events that occur within a set predetermined time period. The log includes source column 302, destination column 304, event type column 306, and time column 308. Source column 302 lists the entity that acts as the source of the worm infection threat during a particular worm propagation stage. Destination column 304 lists the entity that acts as the destination of the worm infection threat during the particular worm propagation stage. Event type column 306 lists the particular event type (e.g., event type “X”) that is propagated from its corresponding source entity to its corresponding destination entity. The event type can be an activity that could be related to the propagation of a worm, such as the sending of a particular file (e.g., “sent_file_virus.exe”) or opening of a particular file (e.g., “opened the program file”). It should be appreciated that the particular event type does not limit the invention, except to the extent that the various event instances that are monitored and tracked have the same event type. Moreover, prior knowledge of a particular computer worm is not required for identification of a potential worm infection threat. Time column 308 lists the timestamp marking the time in which the particular event type occurs.

FIG. 4 depicts an exemplary subset 400 of the attack pattern shown in FIGS. 2 and 3. According to this exemplary subset, the tracked events, in combination, match the attack pattern. For example, a potential attack pattern includes the propagation of an event “X” from entity 202a to entity 202c, which in turn, propagates the same event of type “X” to entities 202d -202g. In this regard, entity 202c is an intermediary in the propagation of type “X” event from the first source (i.e., entity 202a) and second destinations (i.e., entities 202d-202g). WIP utility 148 (FIG. 1) includes counter 149 (FIG. 1) that tracks the various events that occur within a predetermined time period and statistically determines whether the rate of propagation (i.e., infection attempts) of the logged events confirms a worm attack on a computer network. In the example shown in FIG. 4, first destination entity 202c and three infection attempts (“C” to “D”, “C” to “E”, and “C” to “F”) are identified as the exemplary subset within an exemplary predetermined time period. The time period has been set to 10 minutes from the timestamp marking the infection of the first destination entity/intermediary 202c (i.e., between 10:07 and 10:17).

However, it should be appreciated that the invention is not limited to the number of intermediaries (i.e. first destinations) and/or the number of infection attempts that are tracked as having the same event type. To statistically reduce the number of false positives in identifying a worm attack on a computer network, WIP utility 148 can identify additional intermediaries within a set predetermined time period. For example, first destination entity 202d can be identified has also having received an event of type “X” from first source entity 202a. Moreover, additional infection attempts, such as “C” to “G” and “D” to “H” can also be identified by the counter 149. According to another embodiment, those skilled in such additional intermediaries can be positioned in series, in parallel, or as a combination of both.

FIG. 5 is a flow-chart 500 of an exemplary method containing steps for identifying a worm attack on a computer network, according to an embodiment of the present invention According to the present invention, the exemplary method in FIG. 5 is implemented in WIP utility 148 of FIG. 1 and exemplary illustrations 200, 300, and 400 of FIGS. 2, 3, and 4 respectively. After initiator block 502, a predetermined time period for monitoring one or more non-packet events from among a plurality of network events is set (block 504). As used herein, a non-packet event refers to a computer event whose description is based on log entries, which are not contained within data that is captured at the packet-level. Such non-packet data are easier to access than packet-level data, thus saving time and system resources. It should be noted that the predetermined time period that is set is a tunable parameter, which can be modified depending on the level of statistical confidence that is desired.

From block 504, the method continues to block 506, where one or more log entries associated with the non-packet event(s) are received. The one or more received log entries identify a first source of a worm infection threat, at least one first destination of the worm infection threat, a first timestamp of the worm infection threat, and a non-packet event type of the worm infection threat. For example, in the exemplary worm attack pattern shown in FIG. 2 and exemplary table log 300 shown in FIG. 3, the first source of the worm infection threat is entity 202a, which propagates event “X” at timestamps 10:05, 10:07, and 10:09 to each of first destinations 202b-202d, respectively. The log entry or entries are stored in computer memory, such as system memory 136 (FIG. 1), hard drive 134 (FIG. 1), and the like, as depicted in block 508.

From block 508, the method continues to block 510, where an infection attempt threshold value is defined. The infection attempt threshold value is a tunable parameter with which WIP utility 148 compares the number of actual infection attempts within a predetermined time period. At block 512, counter 149 is configured to record within the predetermined time period the number of infection attempts by the one or more first destinations of the worm infection threat (e.g., entities 202b-202d) to one or more second destinations of the worm infection threat (e.g., entities 202d-202h). The infection attempts that are recorded in table log 400 are associated with the same non-packet event type, such that the worm infection threat has the same non-packet event type in the first source (e.g., entity 202a), the one or more first destinations (e.g., entities 202b-d), and the one or more second destinations (e.g., entities 202d-202h). However, it should be appreciated that not all first destinations and/or second destinations must be recorded. For example, table log 400 only lists four non-packet events of the same “X” type. This is because the exemplary counter 149 has been set to monitor one intermediary “C” and infection attempts that occur within a predetermined 10 minute time period from the initial infection of intermediary “C”.

At decision block 514, a determination is made whether the number of infection attempts recorded in counter 149 satisfies the infection attempt threshold value within the predetermined time period. If the number of infection attempts recorded within the predetermined time period satisfies the infection attempt threshold value, WIP utility 148 communicates an alert that confirms a worm attack (block 516) and the process ends at termination block 518. However, if the number of infection attempts recorded within the predetermined time period does not satisfy the infection attempt threshold value, the method continues to decision block 515. At decision block 515, a determination is made whether there are additional non-packet events that have not yet been examined within the predetermined time period for monitoring. If it is determined that additional non-packet events have yet to be examined within the predetermined time period, the method proceeds to block 506, where WIP utility 148 receives the log entry or entries relating to the additional non-packet event(s). However, if there are no additional non-packet entries to examine, the method ends at termination block 518.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of identifying a worm attack on a computer network, said method comprising:
setting a predetermined time period for monitoring at least one non-packet event among a plurality of network events;
receiving at least one log entry associated with said at least one non-packet event, wherein said at least one received log entry identifies a first source of a worm infection threat, at least one first destination of said worm infection threat, a first timestamp of said worm infection threat, and a non-packet event type of said worm infection threat;
storing said at least one log entry;
defining an infection attempt threshold value;
configuring a counter for recording within said predetermined time period a number of infection attempts by said at least one first destination of said worm infection threat to at least one second destination of said worm infection threat, wherein said worm infection threat has the same said non-packet event type in said first source, said at least one first destination, and said at least one second destination;
determining whether said number of infection attempts satisfies said infection attempt threshold value; and
responsive to determining said number of infection attempts satisfies said infection attempt threshold value, communicating an alert that confirms said worm attack on said computer network.

2. The method of claim 1, further comprising:
responsive to determining said number of infection attempts do not satisfy said infection attempt threshold value, determining whether additional non-packet events remain un-examined within said predetermined time period.

3. The method of claim 1, wherein said predetermined time period is a tunable parameter that begins from a timestamp that marks an infection of said at least one first destination of said worm infection threat.

4. A data processing system (DPS) comprising:
a processor unit; and
data storage coupled to said processor unit; and
worm infection propagation (WIP) utility code within said data storage and executable by said processor unit to identify a worm attack on a computer network by:
receiving at least one log entry associated with said at least one non-packet event, wherein said at least one received log entry identifies a first source of a worm infection threat, at least one first destination of said worm infection threat, a first timestamp of said worm infection threat, and a non-packet event type of said worm infection threat;
storing said at least one log entry;
defining an infection attempt threshold value;
configuring a counter for recording within said predetermined time period a number of infection attempts by said at least one first destination of said worm infection threat to at least one second destination of said worm infection threat, wherein said worm infection threat has the same said non-packet event type in said first source, said at least one first destination, and said at least one second destination;
determining whether said number of infection attempts satisfies said infection attempt threshold value; and
responsive to determining said number of infection attempts satisfies said infection attempt threshold value, communicating an alert that confirms said worm attack on said computer network.

5. The DPS of claim 4, the WIP utility further having executable code for:
responsive to determining said number of infection attempts do not satisfy said infection attempt threshold value, determining whether additional non-packet events remain un-examined within said predetermined time period.

6. The DPS of claim 4, wherein said predetermined time period is a tunable parameter that begins from a timestamp that marks an infection of said at least one first destination of said worm infection threat.

7. A computer program product comprising:
a tangible computer-usable storage medium having worm infection propagation (WIP) utility program code embodied therein processable by a data processing system (DPS) to identify a worm attack on a computer network, the program code comprising:
program code configured for receiving at least one log entry associated with said at least one non-packet event, wherein said at least one received log entry identifies a first source of a worm infection threat, at least one first destination of said worm infection threat, a first timestamp of said worm infection threat, and a non-packet event type of said worm infection threat;
program code configured for storing said at least one log entry;
program code configured for defining an infection attempt threshold value;
program code configured for configuring a counter for recording within said predetermined time period a number of infection attempts by said at least one first destination of said worm infection threat to at least one second destination of said worm infection threat, wherein said worm infection threat has the same said non-packet event type in said first source, said at least one first destination, and said at least one second destination;
program code configured for determining whether said number of infection attempts satisfies said infection attempt threshold value; and
program code configured for communicating an alert that confirms said worm attack on said computer network in response to determining said number of infection attempts satisfies said infection attempt threshold value.

8. The computer program product of claim 7, further comprising:
computer-usable program code configured for determining whether additional non-packet events remain un-examined within said predetermined time period, in response to determining said number of infection attempts do not satisfy said infection attempt threshold value.

9. The computer program product of claim 7, wherein said predetermined time period is a tunable parameter that begins from a timestamp that marks an infection of said at least one first destination of said worm infection threat.
